(19) United States
(12) Patent Application Publication
(10) Pub. No.: US 2012/0060108 A1
(43) Pub. Date: Mar. 8, 2012

(54) Systems and methods for flexible digital content monetization in a networked environment

(76) Inventor: Gilles Domartini, Amsterdam (NL)

(21) Appl. No.: 12/876,203

(22) Filed: Sep. 6, 2010

(51) Int. Cl. G06F 3/048

(52) U.S. Cl. 715/768

(57) ABSTRACT

A web content monetization system is disclosed that allows a publisher to create content and to hide portions of that content subject to acceptance of certain conditions, such as a payment. The hidden content is determined by the publisher and is bounded by two tags that can be applied to any portion of the content by the publisher. In place of the hidden content is a placeholder that indicates the conditions under which the hidden content is revealed. When the conditions are met, the hidden content is instantly revealed to the user in the online interface. The hidden content is protected by a digital lock and is not accessible in any manner until the applicable conditions are met.

### CROSS-REFERENCE TO RELATED APPLICATIONS

Not Applicable

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD OF THE INVENTION

The following invention relates generally to online content usage and consumption, and more particularly to systems and methods related to content acquisition mechanisms on networked devices.

### BACKGROUND OF THE INVENTION

In the past few years, the online communication channel has emerged as a major communication channel for consumers. This channel allows users to experience content how, when, and where they want it, and in the specific ways they want to experience it.

Today, the content creation market is dominated by advertising business models, and the content creators often get a limited share of the value generated by the content experience. This drives content quality down.

Also, more and more networked devices are being developed (computers, mobile phones, tablets, e-readers, televisions, etc.), making it difficult and costly for the content creators to publish their content as well, as for the user to acquire content.

The revenue models in the digital industry can be summarized as shown in FIG. 1.

First, the content creators can generate money through advertising. This model is split into two areas:
(1) If the platform audience is large enough, they can sell the advertising on their own, like a big portal such as Microsoft or Yahoo!
(2) Or they can choose a syndicated advertising model. A technical solution is being developed that allows any website to participate in the scheme. This is typically what companies like Google have developed with the AdSense solution.

Second, content creators could instead generate money by selling the content available on their platform, most commonly using subscription models. Such subscription models are locked within a certain Web environment (e.g., Financial Times sites network) or technology (e.g., Apple iTunes Store).

There are no syndicated models like there are for advertising. A number of providers try to develop an agnostic subscription model, such as Press+, but they are based on commercial negotiations with each respective website, and can't scale quickly because they don't have a technical innovation that can be replicated across multiple sites.

The systems and methods described herein aim to fix this gap with the development of a technical framework that is highly modular and flexible such that it can work on any website, any platform, and on any networked device.

### BRIEF SUMMARY OF THE INVENTION

The present invention is a network subscription and e-commerce system that may be used for flexible content monetization on multiple online platforms and applications.

The invention may be characterized as a method, comprising the securing of content rights between two digital points at any place chosen by the content creator in a given application page; having a universal Application Programming Interface for flexible content monetization that can be added to any Content Publishing Platform; hiding defined section(s) of content according to given parameters in an application page; storing hidden content in a database and revealing content on user acceptance of monetization conditions; generating a micro-transaction to reveal content; instantly loading the acquired content to a purchaser after the monetization conditions are met; and generating and collecting commissions on fees using short URLs.

The invention may be characterized as a system, comprising a User interface to manage user accounts, send payment requests corresponding to acquisitions of content, and manage a library of acquired content documents; a Content Creator Interface to monitor application page activities, view commissions and receive payment requests; a Content Creator interface that generates two tags based on set criteria, and allows content to be hidden between these two tags; a Content Creator Application, to be integrated into existing content publishing platforms, allowing precise and flexible tagging of the content and turn it into monetized solutions; an accounts and rights management platform, to define and control the content parameters and manage transactional flows between users, content creators and publishers; a payment interface to initiate transfer to various billing entities; and a short URL interface to manage leads flow and allocate sales communication to content referrers.

An aspect of the present invention is a digital content system, comprising: digital content; wherein the digital content comprises visible content and hidden content; code to display the digital content, comprising: a first tag, a second tag, and at least one condition for revealing the hidden content; wherein the hidden content is located between the first tag and the second tag; and content display means; wherein the code is executed by the content display means; wherein the visible content is visible on the content display means; wherein the hidden content is not visible on the content display means; and wherein the hidden content is instantly visible on the content display means when the at least one condition for revealing the hidden content is met.

In one embodiment of this aspect, the visible content and the hidden content are determined by a content creator or a content publisher. In another embodiment, the first tag is a start tag; and the second tag is an end tag. Another embodiment further comprises a short URL; wherein the hidden content is referred to via the short URL. Another embodiment further comprises a short URL; wherein the short URL monitors referrals to the digital content; and wherein commissions are paid based on the referrals to the digital content. In yet another embodiment, the at least one condition comprises making a payment.

Another embodiment further comprises a placeholder; wherein the placeholder appears in place of the hidden content before the at least one condition is met; and wherein the placeholder is removed and the hidden text is revealed when the at least one condition is met. In another mode of this embodiment, the placeholder comprises a description of the at least one condition for revealing the hidden content; and means to enable a user to satisfy the at least one condition. In a still further mode of this embodiment, the placeholder comprises a description of the hidden text.

In another embodiment, the content display means is selected from the group consisting of personal computers, mobile phones, tablet PCs, and Internet-capable devices. Still another embodiment further comprises a plurality of short URLs; wherein the digital content comprises a plurality of hidden content sections; wherein each of the hidden content sections is bounded by a set of first and second tags; wherein the at least one condition precedent comprises conditions for revealing one or more of the hidden content sections; wherein each short URL identifies at least one of the hidden content sections; and wherein either all of or a subset of hidden content sections can be revealed consecutively or concurrently by a user.

Another aspect of the present invention is a digital content system, comprising digital content; means for displaying the digital content to a user; means for denoting a portion of the digital content as hidden content; wherein hidden content is not visible on the means for displaying; means for specifying at least one condition precedent to revealing hidden content; means for determining whether the at least one condition precedent is met; and means for instantly revealing hidden content to a user if the at least one condition is met.

One embodiment of this aspect further comprises means for tracking referrals to the digital content; and means for paying commissions based on the referrals. In one mode of this embodiment, the means for tracking referrals comprises a short-URL format.

In another embodiment, the means for displaying digital content is selected from the group consisting of personal computers, mobile phones, tablet PCs, and Internet-capable devices. In another embodiment, the means for denoting a portion of digital content as hidden content comprises a start tag and an end tag; wherein the hidden content is located between the start tag and the end tag.

A still further aspect of the present invention is a method for using digital content, the steps comprising providing an environment for a content creator or a content publisher to designate portions of digital content as hidden content; wherein the hidden content is located between a first tag and a second tag; wherein at least one condition is specified for revealing the hidden content; determining whether the at least one condition is met; and revealing the hidden content to a user instantly if the at least one condition is met.

One embodiment of this aspect further comprises tracking referrals to the digital content; and paying commissions based on referrals to the digital content. In another embodiment, the first tag is a start tag and the second tag is an end tag.

Further aspects of the invention will be brought out in the following portions of the specification, in which the detailed description is for the purpose of fully disclosing preferred embodiments of the invention without placing limitations thereon.

### BRIEF DESCRIPTION OF THE FIGURES

FIG. 1 is a summary of the revenue models in the digital industry.

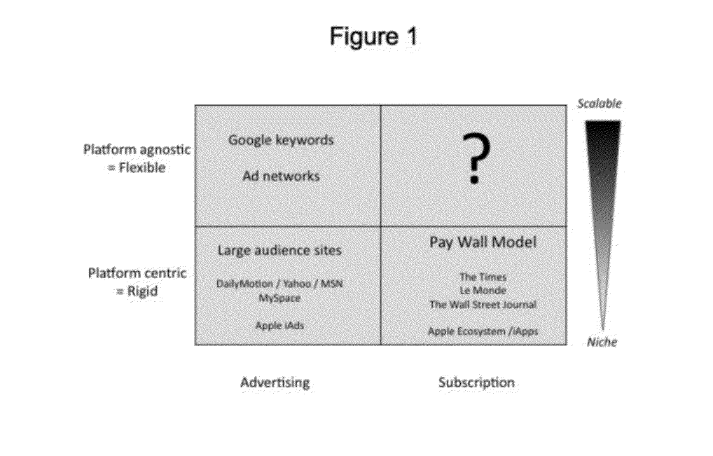

FIG. 2 is an architectural network overview according to an embodiment of the present invention.

FIG. 3 shows a user transaction front view of an application page using a static element according to an embodiment of the present invention.

FIG. 4 shows a user transaction front view of an application page using a dynamic application element according to an embodiment of the present invention.

FIG. 5 shows the Content Creation Unit front view in a Publishing Platform according to an embodiment of the present invention.

FIG. 6 shows a Content Creation Unit front view in an Integrated Publishing Platform according to an embodiment of the present invention.

FIG. 7 is a flow chart illustrating the User Acquisition of a Content Unit according to an embodiment of the present invention.

FIG. 8 is a flow chart illustrating the Creation of System Content Unit as a manual process within a Publishing Platform according to an embodiment of the present invention.

FIG. 9 is a flow chart illustrating the Creation of System Content Unit as automated within an Integrated Publishing Platform according to an embodiment of the present invention.

### DETAILED DESCRIPTION OF THE INVENTION

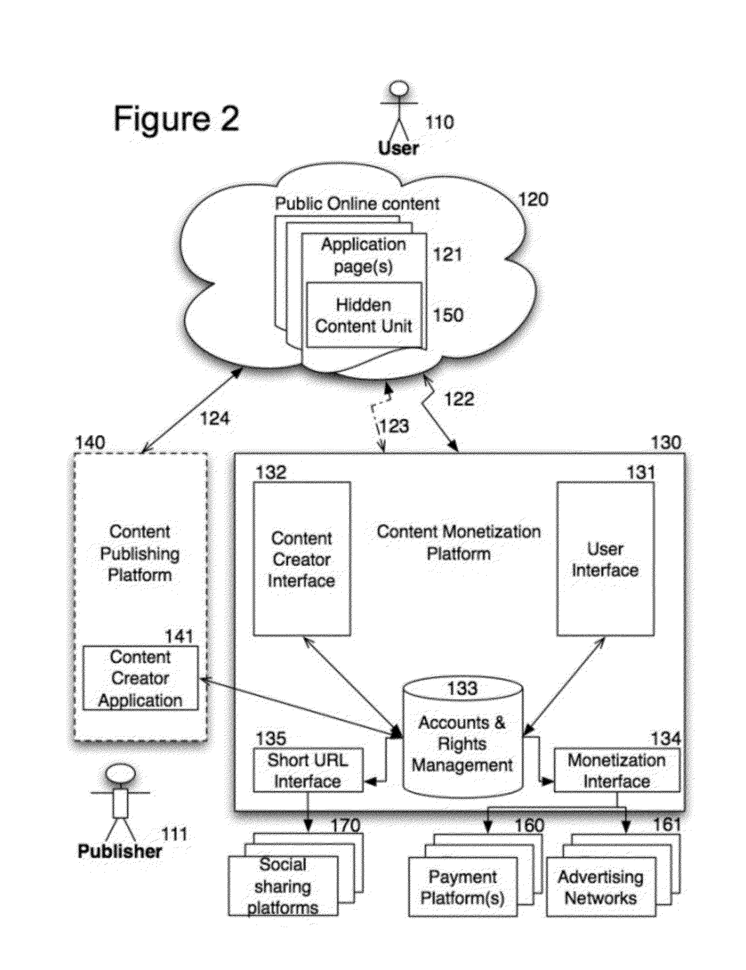

Referring more specifically to the drawings, for illustrative purposes the present invention is embodied in the system and method generally shown in FIGS. 2 through 9. The system may vary as to configuration and as to details of the parts, and the method may vary as to the specific steps and sequence, without departing from the basic concepts as disclosed herein.

In the development of any actual implementation of the present invention, as in any engineering or design project, numerous implementation-specific decisions must be made to achieve the developers' specific goals, such as compliance with system, legal and business related constraints, which may vary from one implementation to another. Moreover, it should be appreciated that such development efforts might be complex and time consuming, but would nevertheless be a routine undertaking of design, fabrication and manufacture for those of ordinary skill in the art having the benefit of this disclosure.

For purposes of the instant specification, the terms “content creator”, “creator”, “content publisher”, and content publisher” are used to denote the person or entity that is the source or creator of the published content and are used interchangeably. The term “user” refers to the one accessing the content that is provided by the creator or publisher. “Content” refers to digital content, which can be static (e.g., text, photos, etc.) or dynamic (e.g., movies, animation, etc.). “Code” refers to any instructions created by the creator or publisher using the system or method of the instant invention that involves content, such as, but not limited to, HTML source code or the output from any other platform involving the creation or display of content.

FIG. 2 illustrates an architectural subscription and e-commerce network that includes a user 110 connecting to the Internet using any Internet-capable device (e.g., personal computer, mobile phone, tablet PC, etc.). Such a device is used for accessing and displaying Public Online content 120 (e.g., a website, web application, etc.) and consulting different application pages 121 (e.g., a web-based text page or content like digital video, graphics, designs, music, etc.) to the user 110. In this embodiment, the application pages 121 contain one Hidden Content Unit 150 and are interacting 122,123 with the Content Monetization Platform 130 that manages a set of Accounts and Rights Management 133 at the core of the embodiment for monetization of the content. It contains an e-commerce solution with a payment interface 134 which has the capacity to handle multiple types of payment platforms 160 (e.g., credit cards, airlines miles, other systems credits) or revenues generated by advertising networks 161. The Accounts and Rights Management controls the logic and conditions parameters that define the Hidden Content Unit 150. Such parameters are set in the Content Creator Application 141, which is part of the Content Publishing Platform 140. The Content Publishing Platform 140 can be any available platform for creating, managing and/or publishing content (e.g., Adobe Creative Suite, WordPress, Joomla!, YouTube, Atex, Facebook, mobile apps, etc.). The Content Publishing Platform 140 is used by the Publisher 111 to create, manage, and/or publish 124 the Public Online Content 120 that the user 110 sees.

To access the monetized content, the users of the system create an account through the User Interface 131. To create the content to monetize, content creators open an account through the Content Creator Interface 132. Using the short URL interface 135, the Content Creators can attribute commissions to Users, who will then receive a commission for the links they share on their social sharing platform 170 (e.g., e-mail, Twitter, Facebook, etc.)

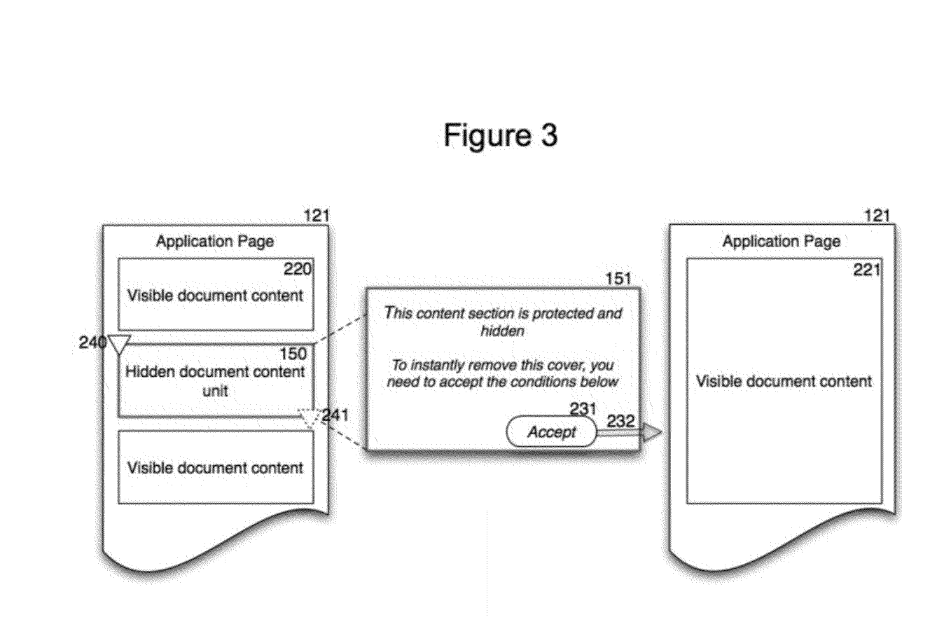

FIG. 3 shows a user transaction front view of an embodiment of the present invention using a static element (e.g., text, photos, etc.). An application page 121 contains different sets of content elements; some elements have visible content 220, and some elements have hidden content and are described as Hidden Content Units 150. Such Hidden Content Units are defined by a start tag 240 and an end tag 241. Any content between these two tags will be hidden, subject to a digital lock. The Hidden Content Unit 150 is a placeholder containing a consumer description 151 of the conditions required to remove the Hidden Content Unit 150. By accepting these conditions 231, the Hidden Content Unit 150 is instantly removed 232, and the application page 121 is now fully visible, in which a single element, Visible Document Content 221, is present. The transaction or activity occurs immediately, without the necessity of opening any new pages or windows during the transaction.

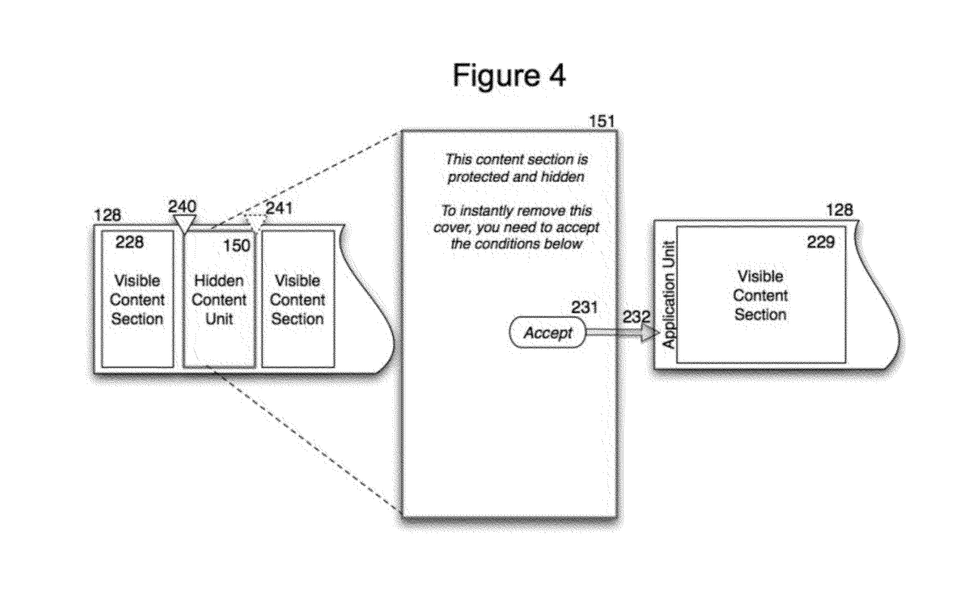

FIG. 4 shows a user transaction front view like that shown in FIG. 3, but using a dynamic content section (e.g., video, slideshows, audio, etc.). During a given section of dynamic content within an application unit 128, some elements are visible 228, while some elements have been covered with a Hidden Content Unit 150 defined by a start tag 240 and an end tag 241. The tags may be activated by set parameters like time, number of frames, content quality, or any other technical parameter desired by the content owner. When reaching the start tag 240, a consumer description 151 gives the conditions required to remove the Hidden Content Unit 150. Similar to FIG. 3, by accepting the condition 231, the digital lock is opened and the full Visible Content Section 229 is available to the user.

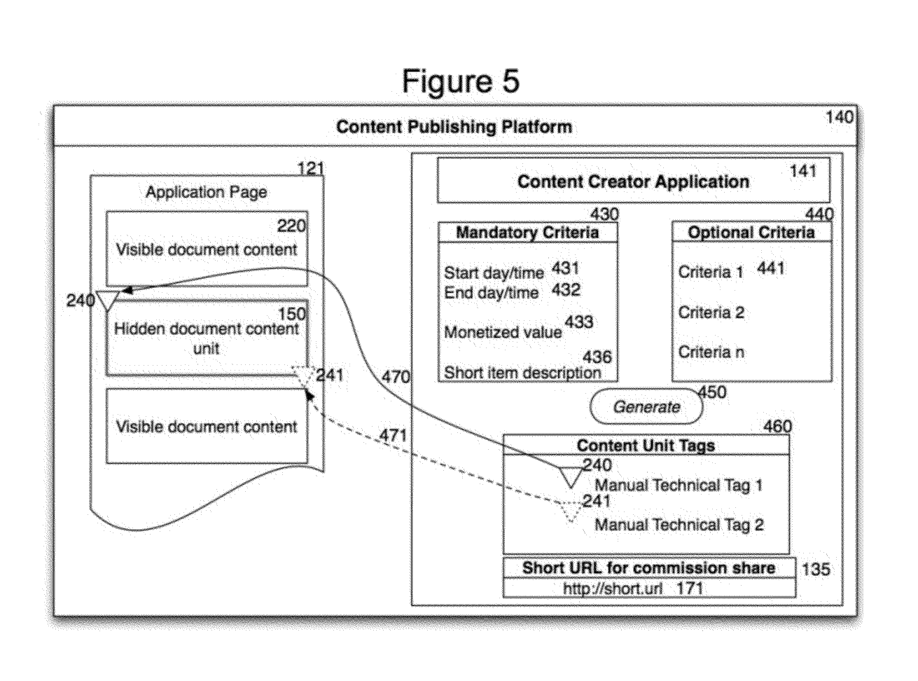

FIG. 5 is an embodiment of the publisher front-view interface. Within the Content Publishing platform 140, a publisher can access the Content Creator Application 141 to create a Hidden Content Unit 150. The Content Creator Application 141 may be seen as a specifically-developed plug-in to the Content Publishing Platform 140, or as a future element added to the platform using the system API (Application Programming Interface). Mandatory Criteria 430 define the required elements to create a monetized Hidden Content Unit 150: A start day/time (DD/MM/YY-24:00) 431, and an end day/time 432 using the same format (these may be added automatically). The monetized element value 433 (price in local currency, or points systems). A short Hidden Content Unit description 436 describes what is hidden behind the Hidden Content Unit and will be displayed within the consumer description 151 seen in FIGS. 3 and 4.

More optional criteria 440 may be found in the interface; such criteria 441 may vary by Content Publishing Platform 140, content types (e.g., digital video, audio, text, images, etc.), or both.

Once the criteria are set, pressing “Generate” 450 would create the start tag 240 and the end tag 241 within the Content Unit Tags element 460. These tags can then be placed manually 470 or automatically 471 within the Application Page 121, and once the content is published, these tags create a Hidden Content Unit 150.

Using the short URL interface 135, a short URL 171 is created to be used for communication of the content and to allow commission management to users sharing the given Application Page 121. The user transaction of such model is shown on FIG. 3.

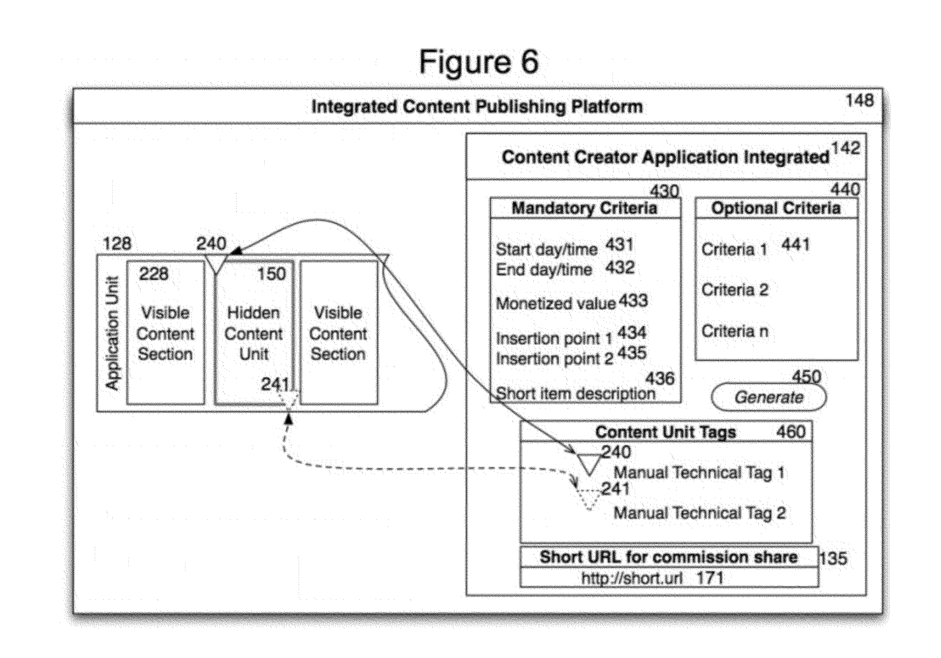

FIG. 6 is an alternative embodiment of the publisher front-view interface, this time using an Integrated Publishing platform 148 to manage a section of dynamic content, such as YouTube videos or SlideShare presentations. A specific Integrated Content Creation Application 142 would have been installed for such a publishing platform. The operative principles are similar to those described in reference to FIG. 5. The difference is, for the setup of the tags, two insertion points should be specified: a first insertion point 434 to start the Hidden Content Unit 150, and a second insertion point 435 to specify the end of the Hidden Content Unit 150. Such insertion points 434,435 can be based on amount of time, number of frames, or any other technical criteria available within the Application Unit 128 or part of the Integrated Publishing Platform 148. The user transaction of such model is shown on FIG. 4.

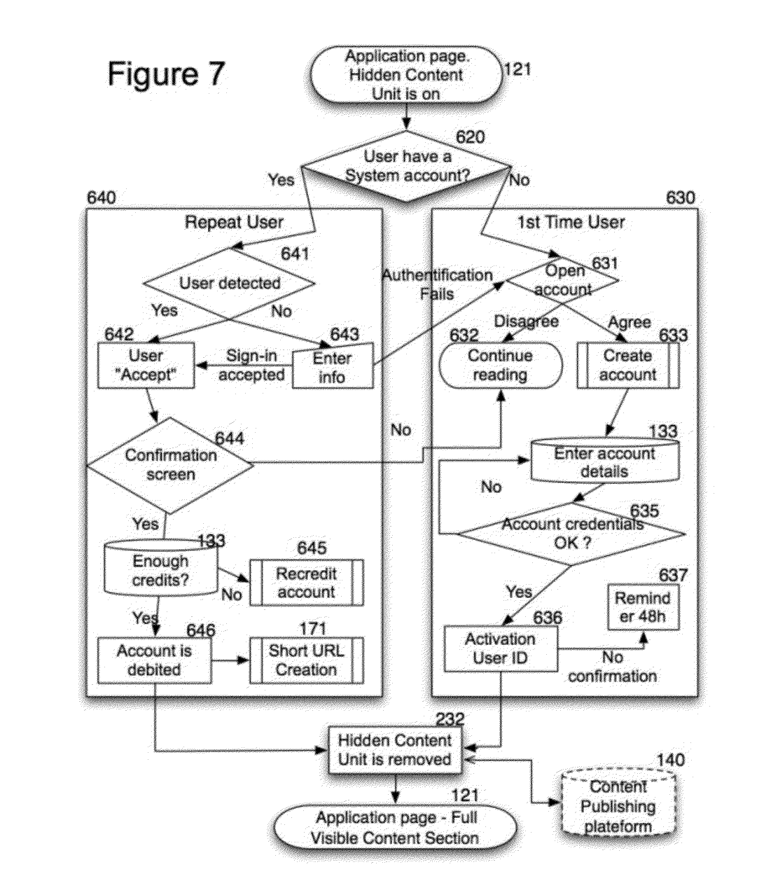

FIG. 7 is a flow chart of the processes and systems involved during the User Acquisition of a Content Unit. At the starting point, a user comes to an application page 121 (or Application Unit 128) in which a Hidden Content Unit 150 is in place. Through standard browser recognition, such as (but not limited to) an Internet Explorer/Firefox cookie, the System detects if the user already has an account 620; if so, it means the user is a repeat user 640. Further user info (e.g., login details) may be detected 641 or the user may manually enter account details 643 if the user info is not detected. Once the user accepts the condition presented 642, a second user confirmation is requested 644, and if confirmed, the system checks account parameters in the Account and Rights database 133. If the account has insufficient credit, the user may recredit his account 645. If enough credits are in the account, the User account is debited 646, and a check is done to determine if the user came from a Short URL link 171. If so, the referrer account is updated as well. The content is then loaded instantly 232 from the Content Publishing Platform 140 into the application page 121 (or the Application Unit 128). Full document content 221 (or Content Section 229) is then visible immediately, without the need for opening any other windows or pages.

If the user comes for the first time and has no account 630, an option to open an account is presented 631. If the user refuses to open an account, the Hidden Content Unit 150 remains on the application page and the user can continue reading the rest of the page 632. If an account is created 633 and user parameters are saved 133, a confirmation request is sent to the new user 635. Upon user confirmation 636, the content is loaded instantly 232 from the Content Publishing Platform 140 into the application page 121 (or Application Unit 128).

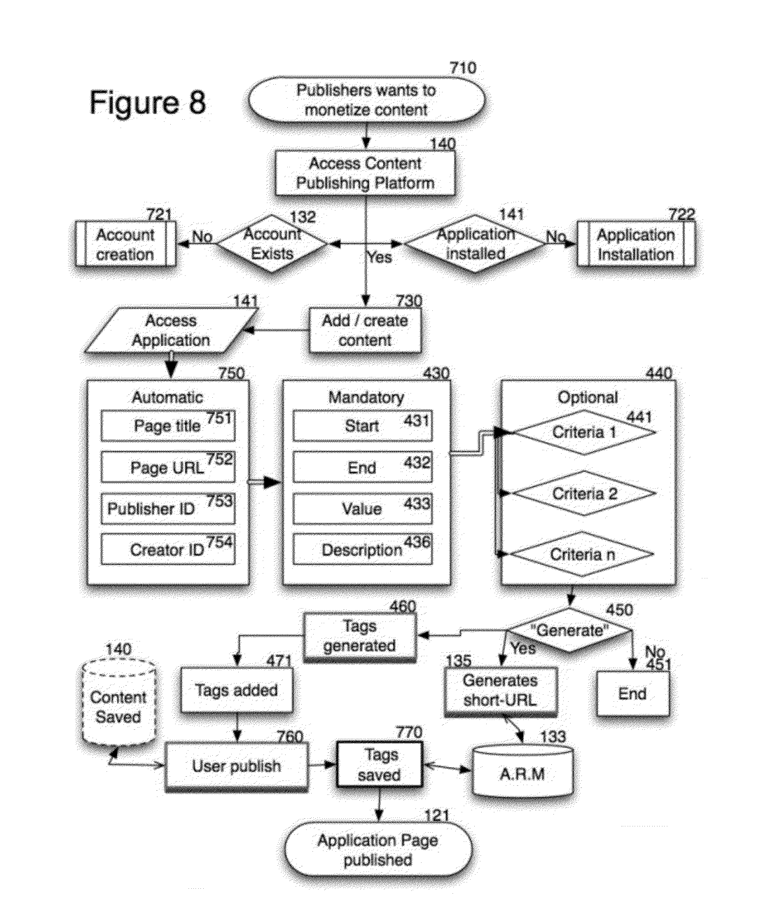

FIG. 8 is a flow chart of the processes and systems involved during the use of the Creation of Content Unit. At the starting point, a Content Creator (e.g., journalist, designer, video, consumer, etc.) wants to monetize the content he has created or is currently creating 710. The Publisher connects to the third-party content publishing platform 140 that he uses to manage, edit, or publish his content. There are two conditions for the system to work: (1) the Content Creator needs to have an account already present in the system 132 or needs to create an account 721, and (2) the Content Creator Application 141 needs to be installed by the Publisher or the Content Creator Application 141 needs to be installed within its third-party Content Publishing Platform 722. The Content Creator starts the editing process of adding, modifying, and/or creating original content 730. He then accesses the Content Creator Application 141. The Content Creator Application 141 will automatically retrieve certain parameters 750, such as, but not limited to, Application page name 751, Application Page URL 752 (http:// . . . ), Publisher ID 753 (if, for example, the Content Creator is affiliated with a larger institution), and Content Creator ID 754. The Content Creator would key-in the mandatory parameters 430, such as start date/time 431, end date/time 432, Monetization Value 433, and short description of the element 436. Some optional parameters 440 can also be added, depending on the platform (e.g., Facebook, WordPress, etc.), the type of content (e.g., video, audio, text, images, etc.), and/or the item activity (e.g., number of views, numbers of monetized units, etc.). After entering the needed parameters, the Content Creator finishes by generating the elements 450. The system generates a short URL to be used for leads and commission management 135, and the parameters are stored with the Accounts and Rights Management platform 133. The start and end tags 240,241 are then created 460 using the parameters set above. The tags 240,241 are added to the Application Page, either manually 470 or automatically 471 as shown in FIG. 5. When the Content Creator decides to publish the Application Page 760, the content contained between the start and end tags 240,241 is saved on the publishing platform 140 and is replaced by the Hidden Content Unit 150. The tags and the latest parameters are saved 770 within the Account and Rights Management platform 133. The application page 121 is now live with Hidden Content Unit 150. The publisher front view interface of such model is shown on FIG. 5.

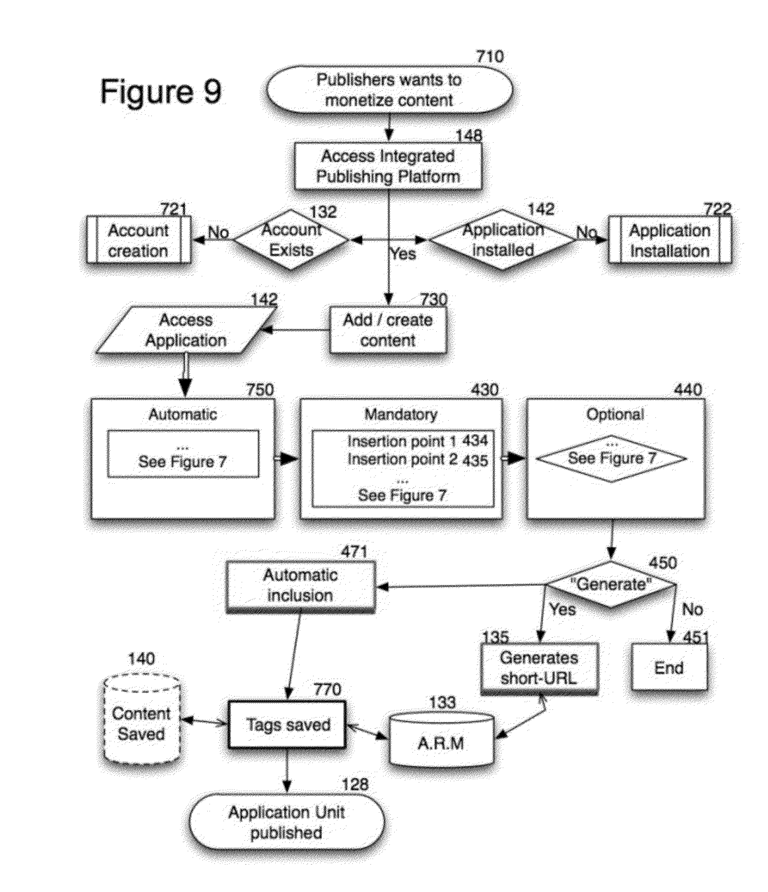

FIG. 9 is a flow chart of an alternative embodiment using an Integrated Publishing platform 148, such as YouTube or SlideShare, in which some insertion points are defined by the content creator (e.g., a specific section of a movie or an animation), and the tags are automatically added during the upload or rendering process. The flow chart sequence is similar to that described in reference to FIG. 8. The Publisher connects to the third-party integrated content publishing platform 148, creates, edits, and/or adds content 730, and accesses the integrated system application 142. Automatic parameters are added 750, and two new mandatory parameters are required: publishers should specify two mandatory insertion points: the first insertion point 434 to start the Hidden Content Unit 150, and the second insertion point 435 to specify the end of the Hidden Content Unit 150. Such insertion points 434,435 can be based on amount of time, number of frames, or any other technical criteria available within the Application Unit 128. Similar to FIG. 8, the publisher clicks “Generate”, the tags are added automatically 471 at the specified insertion points 434,435, and the tags are automatically saved 770 in the content publishing platform 140. The Application Unit 128 is then published. The publisher front view interface of such model is shown on FIG. 6.

The present invention delivers the following key benefits:
(1) From a consumer stand point:
a. Free: Most content can still be enjoyed for free
b. Single sign-on: No need to open multiple subscriptions/accounts with multiple publishers
c. Open: Works on all networked devices using standard Web technology
d. Flexible: User can buy what he wants easily, how and when he wants
e. Instant: Instant gratification when buying content
f. Social: Share content and receive commissions on referrals
(2) From a content creator/publisher stand point, here are some of the key benefits:
a. Quality: Promotes quality by supporting content creation monetization
b. Earnings: Publishers can receive significant new, incremental revenues
c. Control: Publishers keep control of how and what content is being sold
d. Flexibility: Integrates within all types of Web pages and content types
e. Communication: Build buzz on worthy content through use of paid referrals
f. Easy to use: Install within minutes and use within the content publishing platforms

As noted previously, adaptations of the present invention are easily conceived and would exist in the spirit of the original invention. For example, a page may have content from more than one publisher, or may have both static and dynamic content containing hidden content. It is therefore possible to create a page with multiple hidden content sections, each containing content from a different source, and each having a unique short-URL identifier to manage access and commissions. Content on a page may come from the same source, but payment may be made to different entities for revealing specific hidden content on that page. A user may choose to reveal only certain sections of hidden content or all sections of it, subject to the user's needs. For example, the user can reveal any or all hidden content sections during one browsing session or may choose to selectively reveal hidden content sections during different browsing events.

Although the description above contains many details, these should not be construed as limiting the scope of the invention but as merely providing illustrations of some of the presently preferred embodiments of this invention. Therefore, the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, technical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A digital content system, comprising:
digital content;
wherein said digital content comprises visible content and hidden content;
code to display said digital content, comprising:
a first tag,
a second tag, and
at least one condition for revealing said hidden content;
wherein said hidden content is located between said first tag and said second tag; and
content display means;
wherein said code is executed by said content display means;
wherein said visible content is visible on said content display means;
wherein said hidden content is not visible on said content display means; and
wherein said hidden content is instantly visible on said content display means when said condition for revealing said hidden content is met.

2. The system according to claim 1,
wherein said visible content and said hidden content is determined by a content creator or a content publisher.

3. The system according to claim 1:
wherein said first tag is a start tag; and
wherein said second tag is an end tag.

4. The system according to claim 1, further comprising:
a short URL;
wherein said hidden content is referred to via said short URL.

5. The system according to claim 1, further comprising:
a short URL;
wherein said short URL monitors referrals to said digital content; and
wherein commissions are paid based on said referrals to said digital content.

6. The system of claim 1,
wherein said at least one condition comprises making a payment.

7. The system of claim 1, further comprising:
a placeholder;
wherein said placeholder appears in place of said hidden content before said at least one condition is met; and
wherein said placeholder is removed and said hidden text is immediately revealed when said at least one condition is met.

8. The system of claim 7, wherein said placeholder comprises:
a description of said at least one condition for revealing said hidden content; and
means to enable a user to satisfy said at least one condition.

9. The system of claim 7, wherein said placeholder comprises:
a description of said hidden text.

10. The system of claim 1,
wherein said content display means is selected from the group consisting of personal computers, mobile phones, tablet PCs, and Internet-capable devices.

11. The system of claim 1, further comprising:
a plurality of short URLs;
wherein said digital content comprises a plurality of hidden content sections;
wherein each of said hidden content sections is bounded by a set of first and second tags;
wherein said at least one condition precedent comprises conditions for revealing one or more of said hidden content sections;
wherein each said short URL identifies at least one of said hidden content sections; and
wherein either all of or a subset of said hidden content sections can be revealed consecutively or concurrently by a user.

12. A digital content system, comprising:
digital content;
means for displaying said digital content to a user;
means for denoting a portion of said digital content as hidden content;
wherein said hidden content is not visible on said means for displaying;
means for specifying at least one condition precedent to revealing said hidden content;
means for determining whether said at least one condition precedent is met; and
means for instantly revealing said hidden content to a user if said at least one condition is met.

13. The system of claim 12, further comprising:
means for tracking referrals to said digital content; and
means for paying commissions based on said referrals.

14. The system of claim 13,
wherein said means for tracking referrals comprises a short-URL format.

15. The system of claim 12,
wherein said means for displaying said digital content is selected from the group consisting of personal computers, mobile phones, tablet PCs, and Internet-capable devices.

16. The system of claim 12,
wherein said means for denoting a portion of said digital content as hidden content comprises:
a start tag, and
an end tag;
wherein said hidden content is located between said start tag and said end tag.

17. A method for using digital content, the steps comprising:
providing an environment for a content creator or a content publisher to designate portions of digital content as hidden content;
wherein said hidden content is located between a first tag and a second tag;
wherein at least one condition is specified for revealing said hidden content;
determining whether said at least one condition is met; and
revealing said hidden content to a user instantly if said at least one condition is met.

18. The method of claim 17, further comprising
tracking referrals to said digital content; and
paying commissions based on said referrals to said digital content.

19. The method of claim 17,
wherein said first tag is a start tag; and
wherein said second tag is an end tag.
